(19) United States
(12) Patent Application Publication
(10) Pub. No.: US 2013/0115436 A1
(43) Pub. Date: May 9, 2013

(54) INJECTION-MOLDED MULTI-COMPONENT COMPOSITE SYSTEMS HAVING IMPROVED FIRE BEHAVIOUR

(71) Applicants: Rüdiger Hahn, Burscheid (DE); Constantin Schwecke, Alfter (DE); Andreas Müller, Koln (DE); Hans Franssen, Krefeld (DE)

(72) Inventors: Rüdiger Hahn, Burscheid (DE); Constantin Schwecke, Alfter (DE); Andreas Müller, Koln (DE); Hans Franssen, Krefeld (DE)

(73) Assignee: Bayer MaterialScience AG, Leverkusen (DE)

(21) Appl. No.: 13/497,841

(22) PCT Filed: Sep. 20, 2010
(86) PCT No.: PCT/EP10/63816

§ 371 Date: Jan. 22, 2013

(30) Foreign Application Priority Data
Sep. 24, 2009 (DE) 102009042938.7

(51) Int. Cl. B29C 45/00; B32B 27/08; B32B 7/00

(52) U.S. Cl. CPC B29C 45/0003; B32B 7/005; B32B 27/08
USPC 428/213; 264/255

(57) ABSTRACT

The present invention provides entirely or partially injection-moulded multi-component composite systems having improved fire behaviour and a process for their production.

The present invention provides entirely or partially injection-moulded multi-component composite systems having improved fire behaviour and a process for their production.

The development of entirely or partially injection-moulded multi-component composite systems having very low wall thicknesses places very high demands on the individual components in some cases in regard to flow characteristics and fire behaviour. Both properties have an increasingly large role to play: flame retardancy for example because of the safety standards with which companies have to comply. In some circumstances different safety standards have to be complied with, depending on the application. At the same time, however, more and more value is being placed on an attractive design and on meeting the criteria for certain eco-labels. The selection of additives, and in particular of flame retardants, is restricted by such criteria as well as by statutory or standard provisions. The UL listing, based on the fire safety standards of the Underwriters Laboratories testing laboratory, is a generally recognised classification for individual components.

There has thus been no shortage of efforts in the past to improve the flame resistance of thermoplastics. For example, WO 00/26287 A is concerned with improving fire behaviour by reducing the viscosity of polycarbonate in phosphorus-stabilised, extruded polycarbonate sheets containing release agents.

EP-A 1 339 546 discloses thermoformable polycarbonate composites and their use in flame-retardant polycarbonate moulded parts. Thermoformable polycarbonate composites consisting of at least one layer having an LOI value of less than 29 and at least one layer having an LOI value of greater than 29 are claimed. In the further claims and in the examples the application focuses on extruded composites, the layer having the LOI value of less than 29 being a film layer having a thickness of between 30 μm and 500 μm. The materials are said to be suitable for the requirements set in aircraft construction. The extent to which such composites comprising materials having differing fire behaviours are able to achieve a UL classification is not specified. In particular, it does not describe how composites can achieve a good UL listing, despite containing high proportions of material having little or no flame retardancy.

U.S. Pat. No. 4,824,723 too is concerned with extruded multi-layer materials in which a core consisting of a flame-retardant thermoplastic is sheathed with a non-flame-retardant, electrically insulating layer. Thicknesses of generally 4 to 240 mm are specified for the core, 1 to 10 mm for the outer layers. The application is not concerned with materials produced by multi-component injection moulding processes, nor is any mention made of the UL classification of the outer layers and of the thickness ratios to be established for selected materials.

US-A 2008/0014446 describes a flame-retardant multi-layer structure produced by coextrusion, in which however the individual layers are themselves required to have sufficient flame retardancy to pass the required flame test. The present invention shows that this is unnecessary for injection-moulded multi-component composite systems.

WO-A 1999/028128 describes a coextruded multi-layer structure consisting of flame-retardant and non-flame-retardant films. With a thickness of max. 750 μm, the multi-layer structure comprises at least five layers. However, properties of such systems, in particular the fire behaviour, cannot be transferred to injection-moulded multi-component composite systems.

Finally, a laminate consisting of a polycarbonate composition and a process for its production as well as a product consisting of the cited laminate are known from WO2007/024456 A1, wherein the laminate comprises a first and a second layer, the first layer comprising a polycarbonate, a polycarbonate-polysiloxane copolymer, an impact modifier and a polyetherimide, the polycarbonate comprising approx. 50 wt. % of the combined weights of the polycarbonate, the polycarbonate-polysiloxane copolymer, the impact modifier and the polyetherimide. Improved flame retardancy, impact strength and reduced smoke formation if the material is burned are achieved in this way. Flame retardancy in particular, however, is still in need of further improvement. Injection-moulded multi-component composite systems can consist of identical material types, the same material types with different additives, and different materials. The fire behaviour of injection-moulded multi-component composite systems is occasionally unknown. For example, the two layers could become detached and then burn separately. A mutual influencing of the two components is also possible.

Thus if a multi-component composite system requires a fire rating (e.g. UL94-V), this relates to the listed fire rating of each individual component. These individual components then each have to achieve the required rating in their individual wall thickness. Precisely where high standards are demanded in the design field, in particular for transparency, or where the use of certain flame retardants is required to be kept to a minimum or dispensed with altogether, the rating is difficult to achieve for many thermoplastic materials in low wall thicknesses.

An object of the invention is therefore to provide injection-moulded multi-component composite systems that can achieve a certain fire rating in the composite, even though at least one individual component does not achieve this fire rating. A further object of the invention is to provide a method that makes it possible to select suitable materials—in terms of the desired fire retardancy—that are necessary for such a multi-component composite system.

It has now been found that with suitable material combinations, an injection-moulded multi-component composite system can be considered in its total wall thickness in regard to fire behaviour. The material selection of UL-listed plastics (in regard to fire behaviour) is made much simpler by this invention, as the entire component can be regarded as consisting of one material. This is surprising, since the current practice of UL listing has hitherto not allowed for such a view of the system. As is described above, until now only extruded systems having layers of differing flame retardancy have been described, wherein requirements of the individual layers and of the entire system and the solutions that have been presented cannot be compared with the invention presented here. This demonstrates namely that, surprisingly, in entirely or partially injection-moulded multi-component composite systems, extensive possibilities for combining materials arise, depending on the UL listing of the individual components.

The entirely or partially injection-moulded multi-component composite system according to the invention can be either a back-moulded film or a two-component or multi-component injection-moulded composite.

The abbreviations “HB”, “V0”, “V1” and “V2” used in the following applications relate to the corresponding fire protection rating based on the UL flame test, which is described further on.

The multi-component composite system according to the invention has the thickness a+b and contains at least a component A in a thickness a and a component B in a thickness b, wherein

component A) is a back-moulded thermoplastic film or at least one layer of an injection-moulded thermoplastic, the thickness of the film or the thickness of one layer or, in the case of several layers, the total thickness of the layers made from component A being the thickness a, and

component B) is at least one layer of an injection-moulded thermoplastic, the thickness of one layer or, in the case of several layers, the total thickness of the layers made from component B being the thickness b,

and wherein components A and B satisfy one of the following criteria:
1. component A achieves at least V2 in thickness a and only HB in thickness a+b, component B achieves V2 in thickness b and V0 or V1 in thickness a+b, and the ratio a:b is ≦2.5, preferably ≦1.8 and particularly preferably ≦1.2;
2. component A achieves only HB in thickness a and in thickness a+b, component B achieves V0 or V1 in thickness a+b, and the ratio a:b is ≦0.3, preferably ≦0.2; or
3. at least one of components A or B achieves only V2 in thickness a or b respectively and both components achieve V0 or V1 in thickness a+b.

In these cases the entire system surprisingly achieves fire protection rating V0 or V1.

The invention also provides a process for producing such composite systems, consisting of the following steps:
a) selection of suitable materials for components A and B, wherein the selected combination of components satisfies one of criteria 1 to 3,
b) production of an entirely or partially injection-moulded composite system by two-component or multi-component injection moulding processes, by back-moulding a film consisting of component A with component B, or by coating an injection-moulded part consisting of component B with a coating containing component A.

Component A is either an injection-moulded thermoplastic material or a film, or a coating produced directly or from solution. The decisive factor is that component A contains no or only a small amount of flame retardants, such that both in thickness a+b and in thickness a component A does not achieve the flame retardancy properties that are actually required, as determined by the UL classification. Component A can be transparent or non-transparent.

All thermoplastic and thermoplastic-elastic polymers are generally suitable as the thermoplastic material and also as the starting material for producing the film. Unreinforced, reinforced and/or filled plastic based on polyamide (PA), polyesters, in particular polyethylene terephthalate (PET), polybutylene terephthalate (PBT), polyacrylates, in particular polymethyl methacrylate (PMMA), polybutylene terephthalate (PBT), polystyrene (PS), syndiotactic polystyrene, acrylonitrile-butadiene-styrene (ABS), polyolefins, in particular polypropylene (PP), polyethylene (PE), polycarbonate (PC), copolycarbonate (CoPC), copolyester carbonate, TPU, styrene-ethylene-butadiene polymers (SEBS) or a mixture of these plastics are suitable in particular.

In one embodiment the starting material for component A is provided by transparent polymeric materials that are preferably selected from the group consisting of the polymers polyethylene (PE), polypropylene (PP), polyethylene terephthalate (PET), cyanoacrylate (CA), cellulose triacetate (CTA), ethyl vinyl acetate (EVA), propyl vinyl acetate (PVA), polyvinyl butyral (PVB), polyvinyl chloride (PVC), polyester, polycarbonate (PC), copolycarbonate (CoPC), copolyester carbonate, polyethylene naphthalate (PEN), polyurethane (PU), thermoplastic polyurethane (TPU), polyamide (PA), polymethyl methacrylate (PMMA), cellulose nitrate and copolymers of at least two of the monomers of the aforementioned polymers as well as mixtures of two or more of these polymers.

If component A is a prefabricated film, it can be produced by conventional methods by extrusion, from solution or by injection moulding. The film is then placed in the mould and back-moulded with the material of component B.

All polymers known from the prior art that are suitable for coating processes are suitable as coatings. Examples include polymeric esters, carbonates, acrylates, ethers, urethanes or amides, which following application and evaporation of the solvent are mostly also cured, for example by thermal or actinic post-treatment. All conventional coating processes are suitable for coating, for example spraying, flow coating, dipping, roller coating or knife application.

All thermoplastic polymers that can be processed by injection moulding are suitable as the material for component B. Unreinforced, reinforced and/or filled plastic based on polyamide (PA), polyesters, in particular polyethylene terephthalate (PET), polybutylene terephthalate (PBT), polyacrylates, in particular polymethyl methacrylate (PMMA), polybutylene terephthalate (PBT), polystyrene (PS), syndiotactic polystyrene, acrylonitrile-butadiene-styrene (ABS), polyolefins, in particular polypropylene (PP), polyethylene (PE), polycarbonate (PC), copolycarbonate (CoPC), copolyester carbonate, TPU or a mixture of these plastics are again suitable in particular.

In step a) of the process according to the invention components A and B are selected so as to satisfy one of criteria 1 to 3. Furthermore, the adhesion of component A to component B must be guaranteed.

In step b) of the process according to the invention the component is produced, in particular by a multi-component injection moulding process or by film back-moulding, both of which are sufficiently known in principle from the prior art.

Regarding the adhesion properties of plastics and the corresponding production processes, reference is made by way of example to the detailed description in Handbuch Spritzgieβen (ISBN 3-446-15632-1—Carl Hanser Verlag 2001), chapter “6.5 Verbinden mehrerer Komponenten beim Spritzgieβen”, multi-component injection moulding p. 488, 489, 505, 508, 510, 514, 527/adhesion of component A to B p. 517/film back-moulding p. 566, 573.

Unexpectedly it has now been found that although component B in thickness a+b must achieve the flame retardancy properties that are actually required, as determined by the UL rating, it does not need to achieve the fire protection rating in thickness b. The decisive factor is that the combination of layers consisting of component A and component B satisfies one of the above criteria 1 to 3.

The invention relates in particular to composite components that because of their complex geometry and/or integration of functions, for example the integration of screw bosses, cannot be produced by extrusion or coextrusion processes or can be so produced only with considerable effort.

The materials of components A and B can contain further additives in addition to the flame retardants. In principle there are no restrictions governing the choice of additives. Possible additives are described for example in WO 99/55772, p. 15-25, EP 1 308 084 and in the corresponding chapters of “Plastics Additives Handbook”, ed. Hans Zweifel, 5^{th} Edition 2000, Hanser Publishers, Munich.

The following additives can be included, for example: dyes, i.e. inorganic and organic dyes and pigments, release agents, lubricants, flow control agents, UV stabilisers, IR absorbers, flame retardants, optical brighteners, inorganic and organic light-scattering particles, antistatics, heat stabilisers, nucleating agents, fillers, glass spheres, glass and carbon fibres, impact modifiers and carbon nanotubes. The dyes and pigments can be organic or inorganic, for example titanium dioxide, barium sulfate and zinc oxide. Carbon black and metal spangles are also used. Examples of polymeric light-scattering particles are polyacrylates and PMMA, for example core-shell acrylates, polytetrafluoroethylenes, polyalkyl trialkoxysiloxanes and mixtures of these components. UV absorbers belong for example to the classes of benzotriazoles, oxalanilides, 2-cyanoacrylates, benzylidene malonates and formamidines as well as benzophenones, in particular dibenzoyl resorcinols, and triazines, in particular 2-(2-hydroxyphenyl)-1,3,5-triazines.

Component B and optionally component A contain flame retardants, the selection of which is determined by the type of thermoplastic material used and the fire protection to be achieved.

Phosphorus compounds can be cited as examples of flame retardants, for example those of the general formula (1),

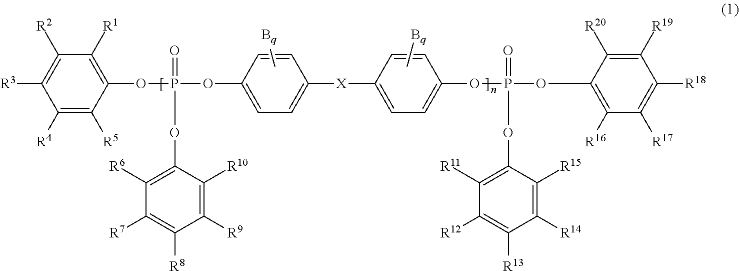

in which
R¹ to R²⁰ independently of each other denote hydrogen, a linear or branched alkyl group having up to 6 C atoms,
n denotes an average value of 0.5 to 50 and
B in each case denotes C₁ to C₁₂ alkyl, preferably methyl, or halogen, preferably chlorine or bromine,
q in each case independently denotes 0, 1 or 2,
X denotes a single bond, C═O, S, O, SO₂, C(CH₃)₂, C₁-C₅ alkylene, C₂-C₅ alkylidene, C₅-C₆ cycloalkylidene, C₆-C₁₂ arylene, to which further aromatic rings optionally containing heteroatoms can be fused, or a radical of formula (2) or (3)

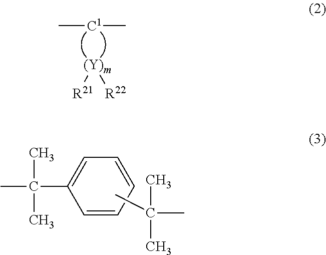

in which Y denotes carbon and
R²¹ and R²² can be selected individually for each Y and independently of each other denote hydrogen or C₁ to C₆ alkyl, preferably hydrogen, methyl or ethyl,
m denotes a whole number from 4 to 7, preferably 4 or 5, with the proviso that on at least one Y atom R²¹ and R²² are both alkyl.

Such phosphorus compounds of formula (1) are preferred in particular in which R¹ to R²⁰ independently of each other denote hydrogen or a methyl radical and in which q=0. Compounds are preferred in particular in which X denotes SO₂, O, S, C═O, C₂-C₅ alkylidene, C₅-C₆ cycloalkylidene or C₆-C₁₂ arylene. Compounds in which X═C(CH₃)₂ are most particularly preferred.

The degree of oligomerisation n is calculated as the average value from the production process for the phosphorus-containing compounds listed. The degree of oligomerisation here is generally n<10. Compounds having a value for n of 0.5 to 5 are preferred, particularly preferably 0.7 to 2.5. Compounds having a high proportion of molecules with n=1 of between 60% and 100%, preferably between 70 and 100%, particularly preferably between 79% and 100%, are most particularly preferred. For production reasons the above compounds can also contain small amounts of triphenyl phosphate. The cited phosphorus compounds are known (cf. for example EP-A 363 608, EP-A 640 655) or can be produced by known methods in an analogous manner (e.g. Ullmanns Enzyklopädie der technischen Chemie, vol. 18, p. 301 ff. 1979; Houben-Weyl, Methoden der organischen Chemie, vol. 12/1, p. 43; Beilstein vol. 6, p. 177).

Alkali or alkaline-earth salts of aliphatic or aromatic sulfonic acid, sulfonamide and sulfonimide derivatives inter alia can furthermore be used as flame retardants, for example sodium or potassium perfluorobutane sulfate, sodium or potassium perfluorooctane sulfate, sodium or potassium diphenyl sulfone sulfonate and sodium or potassium-2,4,6-trichlorobenzoate and N-(p-tolylsulfonyl)-p-toluene sulfimide potassium salt and N-(N′-benzyl aminocarbonyl)sulfanylimide potassium salt. Potassium perfluorobutane sulfonate is commercially available inter alia as Bayowet® C4 (Lanxess, Leverkusen, Germany), RM64 (Miteni, Italy) or as 3M™ Perfluorobutanesulfonyl Fluoride FC-51 (3M, USA).

Halogen-containing flame retardants are for example brominated compounds such as brominated oligocarbonates, for example tetrabromobisphenol-A oligocarbonate BC-52®, BC-58®, BC-52HP® from Chemtura. Also to be mentioned are polypentabromobenzyl acrylates (e.g. FR 1025 from Dead Sea Bromine (DSB)), oligomeric reaction products of tetrabromobisphenol A with epoxides (e.g. FR 2300 and 2400 from DSB), or brominated oligo- or polystyrenes (e.g. Pyro-Chek® 68PB from Ferro Corporation, PDBS 80 and Firemaster® PBS-64HW from Chemtura).

Incorporation of the additives into the thermoplastics is performed using conventional mixing processes and can be performed for example by mixing solutions of the additives with a solution of polycarbonate in suitable solvents such as dichloromethane, haloalkanes, halogen aromatics, chlorobenzene and xylenes. The mixtures of substances are then preferably homogenised in the known manner by extrusion. The mixtures of solutions are preferably processed in the known manner by evaporation of the solvent and subsequent extrusion.

The composition can additionally be mixed in conventional mixing devices such as extruders (for example twin-screw extruders), compounders, Brabender or Banbury mills, and then extruded. Following extrusion the extrudate can be cooled and shredded. Individual components can also be pre-mixed and then the remaining starting materials added individually and/or likewise in a mixture.

The additives, in particular flame retardants and/or UV absorbers, can also be added to the starting materials by means of concentrates (masterbatches). In this process the additive(s) are incorporated into a thermoplastic support in as high a concentration as possible by one of the methods of incorporation described above. The additive concentrate is then mixed into the thermoplastic before processing so as to obtain the desired final concentration of the additive.

In a further variant many thermoplastics can also be obtained commercially as variants containing halogenated or halogen-free flame retardants.

In various embodiments the flame-retardant component B is constituted for example by commercially available polycarbonates and polycarbonate/ABS blends, component A by weakly flame-retardant or non-flame-retardant polycarbonates in injection moulding quality or by polycarbonate or TPU films.

Component A can consist of one material and one layer or of a plurality of materials and a plurality of layers. In this case the cumulated total thickness of the individual layers should be classed as thickness a.

Component B can consist of one material and one layer or of a plurality of materials and a plurality of layers. In this case the cumulated total thickness of the individual layers should be classed as thickness b.

In a particular embodiment component B contains ≧95 wt. % of polycarbonate and at least 0.05 wt. %, preferably 0.1 wt. % of Teflon and also further flame retardants, and component A contains ≧95 wt. % of polycarbonate, and component A achieves at least V2 in thickness a and only HB in thickness a+b, component B achieves V2 in thickness b and V0 or V1 in thickness a+b and the ratio a:b is ≦2.5, preferably ≦1.8 and particularly preferably ≦1.2.

Thickness a, thickness b and total thickness a+b are understood to be the (wall) thicknesses in the component that are relevant for a UL listing of the relevant materials. However, only the aforementioned criteria can be considered as decisive for the selection of materials for the components.

The total thickness a+b in the component is preferably 1 to 10 mm and most particularly preferably 2 to 8 mm.

The novel process for producing such composite systems, consisting of the following steps a-b):
a) selection of suitable materials for components A and B, wherein the selected combination satisfies one of the following criteria 1 to 3:
   1.) component A achieves at least V2 in thickness a and only HB in thickness a+b, component B achieves V2 in thickness b and V0 or V1 in thickness a+b, and the ratio a:b is ≦2.5, preferably ≦1.8 and particularly preferably ≦1.2;
   2.) component A achieves only HB in thickness a and in thickness a+b, component B achieves V0 or V1 in thickness a+b, and the ratio a:b is ≦0.3, preferably ≦0.2; or
   3.) at least one of components A or B achieves only V2 in thickness a or b respectively and both components achieve V0 or V1 in thickness a+b;
b) production of an entirely or partially injection-moulded composite system by two-component or multi-component injection moulding processes, by back-moulding a film consisting of component A with component B, or by coating an injection-moulded part consisting of component B with a coating containing component A;
   provides a simple process that allows the user to select from a markedly larger number of materials than hitherto for entirely or partially injection-moulded multi-component systems. At the same time, however, it is unnecessary to determine the optimum material combination in time-consuming trial-and-error tests; instead the criteria according to the invention make it possible to select materials with the aid of UL characteristics of the individual components.

### EXAMPLES

1. Materials Used

The thermoplastic materials used are polycarbonates of the Makrolon® type, polycarbonate/ABS blends of the Bayblend® type and polycarbonate films of the Makrofol® type, from Bayer MaterialScience AG, Germany. The following types having the specified characteristics were used:

M1: Makrolon® 6555: Polycarbonate, MVR (300° C./1.2 kg) 9.5 cm³/10 min; containing chlorine- and bromine-free flame retardant; UL 94V-0/3.0 mm; medium viscosity; easily demoulded

M2: Makrolon® 6557: Polycarbonate; MVR (300° C./1.2 kg) 9.5 cm³/10 min; containing chlorine- and bromine-free flame retardant; UL 94V-0/3.0 mm; medium viscosity; UV-stabilised; easily demoulded

M3: Makrolon® DP1-1884: Polycarbonate, MVR (300° C./1.2 kg) 17 cm³/10 min; containing chlorine- and bromine-free flame retardant; low viscosity; easily demoulded

M4: Makrolon 1952: Polycarbonate, MVR (300° C./1.2 kg) 9.5 cm³/10 min; containing chlorine- and bromine-free flame retardant; UL 94V-0/2.3 mm; medium viscosity; easily demoulded

M5: Makrolon® 7101: Polycarbonate, MVR (300° C./1.2 kg) 33 cm³/10 min; special flame retardant system; containing chlorine- and bromine-free flame retardant; UL 94V-0/1.5 mm; low viscosity; easily demoulded; Vicat softening temperature 50 N; 50° C./h=110° C.

M6: Makrolon® 2205: Polycarbonate, MVR (300° C./1.2 kg) 35 cm³/10 min; general purpose; low viscosity; easily demoulded

M7: Bayblend FR3005HF: Polycarbonate/ABS blend, injection moulding grade; very free-flowing; Vicat/B 120=96° C.; UL listing 94 V-0 at 1.5 mm; containing antimony-, chlorine- and bromine-free flame retardant

M8: Bayblend FR3020: Polycarbonate/ABS blend, containing 5% mineral filler; thin-wall type; injection moulding; Vicat/B 120=103° C.; HDT/A>=85° C.; very good UL listing in low wall thicknesses (V-0 at 0.75 mm), containing antimony-, chlorine- and bromine-free flame retardant

M9: Bayblend FR3021: Polycarbonate/ABS blend, containing 15% mineral filler; injection moulding grade; elevated rigidity; modulus of elasticity=4800 MPa; Vicat/B 120=98° C.; UL listing 94 V-0 at 1.5 mm; containing antimony-, chlorine- and bromine-free flame retardant; glow wire flammability index (GWFI): 960° C. at 20 mm

M10: Bayblend T65XF: Polycarbonate/ABS blend, standard grade; injection moulding; Vicat/B 120=120° C.; improved flow characteristics as compared with T65

M11: Makrofol TP1243: Non-flame-retardant light-scattering polycarbonate film with a thickness of 500 μm

M12: Makrofol FR 7-2: Flame-retardant light-scattering polycarbonate film with a thickness of 500 μm, UL 94V-0/500 μm

2. Production of Injection-Moulded Specimens

Specimens were produced by two-component injection moulding on an Arburg Allrounder 370S 800-150 injection moulding machine with a locking force of max. 800 kN and a screw diameter of 25 mm. A standard mould unit with interchangeable inserts was used to produce Campus specimens of variable thickness (inserts

[ASTM specimen 127×12.7×d, in mm] of thickness 0.8 mm-1.5 mm-2.0 mm-3.0 mm-3.8 mm)

Prior to being used, the materials were each dried using the parameters listed in Table 1. The melt temperatures listed in Table 1 were set for the injection moulding of the materials. In the first step of the two-component injection moulding process, specimens (flame test specimen 125×13×a) of various thicknesses a (e g 0 8 mm/1.5 mm/2.0 mm/3.0 mm) were produced from material component A. In the second step these flame test specimens were placed in a mould having a larger wall thickness b (3.0 mm/3.8 mm) and back-moulded with material component B.

TABLE 1

| | | Melt temperature | Mould temperature |
|---|---|---|---|
| Material | Drying | [° C.] | [° C.] |
| M1 and M2 | 4 h/120° C. | 300 | 80 |
| M3 | 4 h/120° C. | 280 | 80 |
| M4 | 4 h/120° C. | 300 | 80 |
| M5 | 4 h/100° C. | 280 | 80 |
| M6 | 4 h/120° C. | 280 | 80 |
| M7 | 4 h/80° C. | 240 | 80 |
| M8 | 4 h/90° C. | 240 | 80 |
| M9 | 4 h/90° C. | 240 | 80 |
| M10 | 4 h/110° C. | 260 | 80 |

In order to produce Examples 1 to 26, the material components A and B listed in Tables 2 and 3 were processed to form two-component test specimens of thicknesses a and b respectively, and of the resulting total thickness a+b. The test results for the flame tests are likewise listed in Table 2.

For film back-moulding with components A=M11 and M12 (Table 4), the 500-μm films were placed in the flame test specimen moulds (3.2 mm/3 8 mm), back-moulded with component B and likewise tested in the flame test as defined by the standard UL94-V.

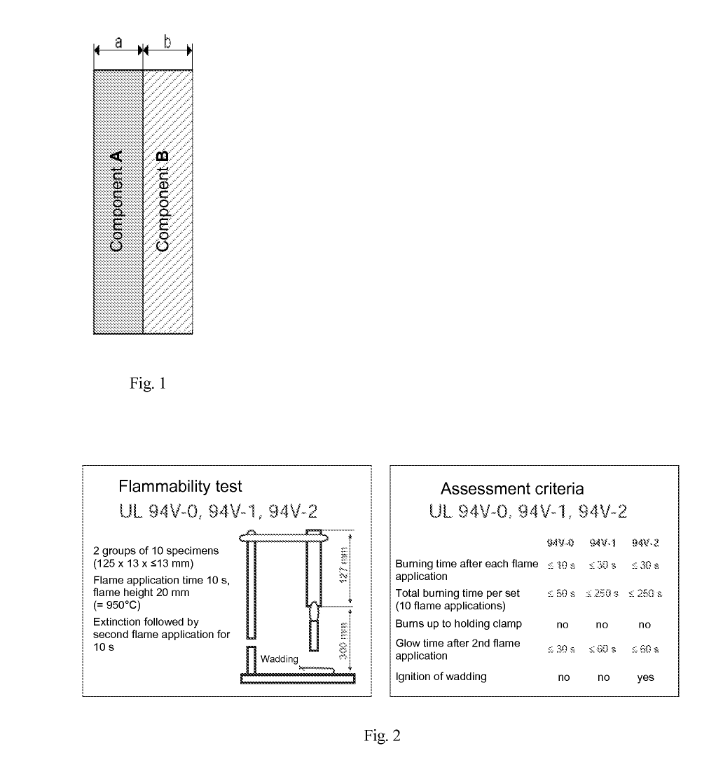

FIG. 1 shows a schematic view of the structure of the two-component injection-moulding test specimen.

3.) Testing:

Testing of the specimens was carried out after storage in accordance with standards in a flame test as defined by the standard UL94-V (cf. FIG. 2).

All results are summarised in Tables 2 to 4 below.

TABLE 2

| | Component A | | | | Component B | | | | | Test | |
|---|---|---|---|---|---|---|---|---|---|---|---|
| | | | UL94 | UL94 listing | | | UL94 | UL94 listing | | UL94 | UL94 |
| Ex. | | Thickness | listing at | at thickness | | Thickness | listing at | at thickness | Ratio | V0/V1 | V2 at |
| no. | Material | a [mm] | thickness a | (a + b) | Material | b [mm] | thickness b | (a + b) | a:b | at 3.0 mm | 3.0 mm |
| 1 | M4 | 1.5 | V2 | V0 | M4 | 1.5 | V2 | V0 | 1.00 | x | |
| 2 | M4 | 1.5 | V2 | V0 | M2 | 1.5 | V2 | V0 | 1.00 | x | |
| 3 | M2 | 1.5 | V2 | V0 | M2 | 1.5 | V2 | V0 | 1.00 | x | |
| 4 | M4 | 1.5 | V2 | V0 | M8 | 1.5 | V0 | V0 | 1.00 | x | |
| 5 | M5 | 1.5 | V0 | V0 | M8 | 1.5 | V0 | V0 | 1.00 | x | |
| 6 | M2 | 1.5 | V2 | V0 | M8 | 1.5 | V0 | V0 | 1.00 | x | |
| 7 | M4 | 1.5 | V2 | V0 | M7 | 1.5 | V0 | V0 | 1.00 | x | |
| 8 | M5 | 1.5 | V0 | V0 | M7 | 1.5 | V0 | V0 | 1.00 | x | |
| 9 | M2 | 1.5 | V2 | V0 | M7 | 1.5 | V0 | V0 | 1.00 | x | |
| 10 | M4 | 1.5 | V2 | V0 | M9 | 1.5 | V0 | V0 | 1.00 | x | |
| 11 | M5 | 1.5 | V0 | V0 | M9 | 1.5 | V0 | V0 | 1.00 | x | |
| 12 | M2 | 1.5 | V2 | V0 | M9 | 1.5 | V0 | V0 | 1.00 | x | |
| 13 | M5 | 1.5 | V0 | V0 | M5 | 1.5 | V0 | V0 | 1.00 | x | |

TABLE 3

| | Component A | | | | Component B | | | | | | | |
|---|---|---|---|---|---|---|---|---|---|---|---|---|
| | | | | UL94 | | | | UL94 | | Test | | |
| | | | UL94 | listing at | | | UL94 | listing at | | UL94 V0 | | UL94 V |
| | | Thickness | listing at | thickness | | Thickness | listing at | thickness | Ratio | or V1 at | UL94 V2 | failed |
| Ex. no. | Material | a [mm] | thickness a | (a + b) | Material | b [mm] | thickness b | (a + b) | a:b | 3.8 mm | at 3.8 mm | at 3.8 mm |
| 14 | M6 | 0.8 | V2 | HB | M3 | 3.0 | V0 | V0 | 0.27 | X | | |
| 15 | M6 | 1.5 | V2 | HB | M3 | 2.3 | V1 | V0 | 0.65 | X | | |
| 16 | M6 | 2.0 | V2 | HB | M3 | 1.8 | V2 | V0 | 1.11 | X | | |
| 17 | M6 | 3.0 | HB | HB | M3 | 0.8 | V2 | V0 | 3.75 | | X | |
| 18 | M1 | 0.8 | V2 | V0 | M3 | 3.0 | V0 | V0 | 0.27 | X | | |
| 19 | M1 | 1.5 | V2 | V0 | M3 | 2.3 | V1 | V0 | 0.65 | X | | |
| 20 | M1 | 2.0 | V2 | V0 | M3 | 1.8 | V2 | V0 | 1.11 | X | | |
| 21 | M10 | 1.5 | HB | HB | M3 | 2.3 | V1 | V0 | 0.65 | | | X |
| 22 | M10 | 2.0 | HB | HB | M3 | 1.8 | V2 | V0 | 1.11 | | | X |

TABLE 4

| | | | | | | | | | | Test |
|---|---|---|---|---|---|---|---|---|---|---|
| | Component A | | | | Component B | | | | | UL94 V0 or |
| | | | | UL94 listing | | | | UL94 listing | | V1 at |
| Ex. | | Thickness | UL94 listing | at thickness | | Thickness | UL94 listing at | at thickness | | thickness |
| no. | Material | a [mm] | at thickness a | (a + b) | Material | b [mm] | thickness b | (a + b) | Ratio a:b | (a + b) |
| 23 | M11 | 0.5 | HB | HB | M1 | 3.3 | V0 | V0 | 0.15 | X |
| 24 | M12 | 0.5 | V0 | V0 | M1 | 3.3 | V0 | V0 | 0.15 | X |
| 25 | M11 | 0.5 | HB | HB | M1 | 2.7 | V2 | V0 | 0.19 | X |
| 26 | M12 | 0.5 | V0 | V0 | M1 | 2.7 | V2 | V0 | 0.19 | X |

Unexpectedly, a wide variety of fire-retardant combinations of the two-component flame test specimens that were produced and tested achieved fire rating UL94 V-0, or at least UL94 V 1. An improvement in the fire rating was found even in flame-retardant materials in which the individual layers would not achieve these fire ratings.

The combinations of flame-retardant and non-flame-retardant specimens (film) were particularly surprising. Results of even UL94 V0 N1 were achieved here, when in some cases up to more than half of the total thickness of 3 8 mm consisted of non-flame-retardant material and/or the individual components in thickness a or b respectively both achieved only V2.

In Examples 14 to 16 according to the invention (Table 3), component A achieves at least V2 in thickness a and only HB in thickness a+b, component B achieves V2 in thickness b and V0 or V1 in thickness a+b, but surprisingly the test specimen comprising both components achieves the listing V0. The ratio a:b is ≦2.5.

In Examples 23 and 25 according to the invention (Table 4) A achieves only UL94 listing HB in thickness a and in thickness a+b. The ratio a:b is ≦0.3. Component B achieves UL94 listing V0 or V1 in thickness a+b, whilst surprisingly the test specimen comprising both components achieves the listing V0.

In Examples 1 to 4, 6 to 7, 9 to 10 and 12 according to the invention (Table 2) and Examples 18 to 20 (Table 3) and 26 (Table 4), at least one of components A or B achieves only V2 in thickness a or b respectively and in thickness a+b both components achieve V0 or V1. Surprisingly the test specimen comprising both components achieves the listing V0.

1-11. (canceled)

12. An entirely or partially injection-moulded multi-component composite system having wall thickness a+b, containing at least one component A in a thickness a and at least one component B in a thickness b, wherein
component A) is a back-moulded thermoplastic film or at least one layer of an injection-moulded thermoplastic, the thickness of the film or the thickness of one layer or, in the case of several layers, the total thickness of the layers made from component A being the thickness a, and
component B) is at least one layer of an injection-moulded thermoplastic, the thickness of one layer or, in the case of several layers, the total thickness of the layers made from component B being the thickness b,
and wherein components A and B satisfy one of the following criteria:
(1) component A achieves at least V2 in thickness a and only HB in thickness a+b, component B achieves V2 in thickness b and V0 or V1 in thickness a+b, and the ratio a:b is ≦2.5;
(2) component A achieves only HB in thickness a and in thickness a+b, component B achieves V0 or V1 in thickness a+b, and the ratio a:b is ≦0.3; or
(3) at least one of components A or B achieves only V2 in thickness a or b respectively and both components achieve V0 or V1 in thickness a+b.

13. The multi-component composite system of claim 12, wherein component A achieves at least V2 in thickness a and only HB in thickness a+b, component B achieves V2 in thickness b and V0 or V1 in thickness a+b, and the ratio a:b is ≦2.5.

14. The multi-component composite system of claim 12, wherein component A achieves only HB in thickness a and in thickness a+b, component B achieves V0 or V1 in thickness a+b, and the ratio a:b is ≦0.3.

15. The multi-component composite system of claim 12, wherein at least one of components A or B achieves only V2 in thickness a or b respectively and both components achieve V0 or V1 in thickness a+b.

16. The multi-component composite system of claim 12, wherein component A and component B consist of injection-moulded thermoplastics.

17. The multi-component composite system of claim 12, wherein the composite system is a back-moulded film and the film constitutes component A.

18. The multi-component composite system of claim 12, wherein at least one of components A and B contains polycarbonate, copolycarbonate or copolyester carbonate.

19. The multi-component composite system of claim 12, wherein at least component B contains at least one flame retardant.

20. A process for producing an entirely or partially injection-moulded multi-component composite system, comprising the steps of:
a. selecting suitable materials for components A and B such that they satisfy one of the following criteria:
1) component A achieves at least V2 in thickness a and only HB in thickness a+b, component B achieves V2 in thickness b and V0 or V1 in thickness a+b, and the ratio a:b is ≦2.5;
2) component A achieves only HB in thickness a and in thickness a+b, component B achieves V0 or V1 in thickness a+b, and the ratio a:b is ≦0.3; or
3) at least one of components A or B achieves only V2 in thickness a or b respectively and both components achieve V0 or V1 in thickness a+b; and
b. producing an entirely or partially injection-moulded composite system by two-component or multi-component injection moulding processes, by back-moulding a film consisting of component A with component B, or by coating an injection-moulded part consisting of component B with a coating containing component A.

21. The process of claim 20, wherein the production process in step b) is a two-component or multi-component injection-moulding process.

22. The process of claim 20, wherein the production process in step b) is the back-moulding of a film consisting of component A with component
